(19) United States
(12) Patent Application Publication
(10) Pub. No.: US 2020/0314129 A1
(43) Pub. Date: Oct. 1, 2020

(54) NETWORK ROUTE LEAKAGE DETECTION

(71) Applicant: Saudi Arabian Oil Company, Dhahran (SA)

(72) Inventor: Sultan Z. Alkhaldi, Hafer AlBating (SA)

(21) Appl. No.: 16/369,124

(22) Filed: Mar. 29, 2019

(51) Int. Cl. H04L 29/06; H04L 12/751; H04L 12/721; H04L 12/703

(52) U.S. Cl. CPC H04L 63/1425; H04L 45/28; H04L 45/14; H04L 45/02

(57) ABSTRACT

A method of detecting route leakage in a network performed by a processor coupled to the network comprises receiving input of one or more expected routes for the network, receiving a routing table from an IP service provider, determining whether the routing table contains any routes that vary from the expected one or more routes, and generating an alert to a monitoring device if is determined that the routing table contains routes that vary from the expected one or more routes.

### FIELD OF THE DISCLOSURE

The present invention relates to network security, and, more particularly, relates to a method of detecting network route leakage.

### BACKGROUND OF THE DISCLOSURE

Route leakage is a network problem that involves the illegitimate announcement of prefixes in IP addresses by network nodes. Route leaks can propagate across networks and lead to incorrect or suboptimal routing. In some instances, route leaks can occur due to malicious “hijacking,” but most leaks occur inadvertently (e.g., due to filter misconfigurations).

This is a significant problem for virtual private network (VPN) environments as route leaks can be a source of network security breaches. For instance, a service provider could connect two clients to the same VRF (virtual routing and forwarding) by inadvertently assigning the same route target for both clients. In this case, both customers will have network connectivity between their customer edges (CE) and this results in route leakage. The clients will not be aware of the route leakage unless they have duplicated subnets or routes used by both customers. From a security point of view, this arrangement is not a private network. For example, either of the two clients that are connected to the same VRF can potentially cause denial of service to the other by announcing the same route with a longer prefix mask.

It would therefore be advantageous to be able to detect route leakage, particularly at customer edges, to help ensure the privacy of virtual private networks.

### SUMMARY OF THE DISCLOSURE

Embodiments of the present disclosure provide a method of detecting route leakage in a network performed by a processor coupled to the network. The method comprises receiving input of one or more expected routes for the network, storing the received input, receiving a routing table from an IP service provider, determining whether the routing table contains any routes that vary from the expected one or more routes, and generating an alert to a monitoring device if is determined that the routing table contains routes that vary from the expected one or more routes.

In certain implementations, the input route or routes (more generally, “routes,” though the singular is included in this term) include either a list or a range of IP addresses. In other implementations, the input routes include one of a list of autonomous systems (AS) and complete AS paths used in border gate protocol (BGP) messaging. It is noted that an AS path can also be inserted using regular expressions. In further implementations, the input routes include both a) one of a list and a range of IP addresses, and b) one of a list of autonomous systems (AS) and complete AS paths used in border gate protocol (BGP) messaging.

In certain embodiments, the network is a virtual private network.

In further embodiments, the method can also include generating, at the monitoring device, a communication to inform the IP service provider or the network administrator of a route leak received by the network.

In certain embodiments, the method is performed at a customer edge (CE) router of the network coupled directly to a provider edge (PE) router of the IP service provider. In other embodiments, the method is performed by a monitoring system coupled to the network. In addition, the method can also be performed in private MPLS (multiprotocol label switching) networks in which the customer has its own network segregation. The method can be used to detect inter-VRF route leakage. In this case the method can be performed in a PE router having connectivity to all of the VRF's or the route reflector router.

In certain embodiments, the method includes communicating the generated alert so as to trigger a security feature employed in the network. The security feature can be an artifact analysis system that analyzes the routes that vary from the one or more expected routes and stores the routes in a centralized database.

Embodiments of the present disclosure further includes a non-transitory computer-readable medium comprising instructions which, when executed by a computer system, cause the computer system to carry out a method detecting route leakage in a network including steps of receiving input of one or more expected routes for the network, storing the received input, receiving a routing table from an Customer edge or Provider edge router, determining whether the routing table contains any routes that vary from the expected one or more routes, and generating an alert to a monitoring device if is determined that the routing table contains routes that vary from the expected one or more routes.

In certain embodiments, the non-transitory computer-readable medium further includes instructions for performing the step of generating, at the monitoring device, a communication to inform the IP service provider and/or the network administrator of a route leak received by the network.

These and other aspects, features, and advantages can be appreciated from the following description of certain embodiments of the invention and the accompanying drawing figures and claims.

### BRIEF DESCRIPTION OF THE DRAWINGS

FIG. 1 is a schematic diagram of an exemplary IP data communication network in which the methods disclosed herein can be implemented.

FIG. 2 is a flow chart of an embodiment of a method of detecting network route leakage according to the disclosure.

FIG. 3 is an example route table received at a customer edge router.

### DETAILED DESCRIPTION OF CERTAIN EMBODIMENTS OF THE DISCLOSURE

Methods disclosed herein aim to solve the problem of route leakage, particularly in VPN environments, by monitoring the routes received from the service provider, detecting any unexpected routes, and sending an alert if unexpected routes are detected. More particularly, to better ensure that no route leakage has occurred, embodiments of the method of detecting network route leakage include receiving an expected IP route address (or range) and/or AS paths (if Border Gateway Protocol (BGP) is used), storing the received IP route address and/or AS paths, scanning a routing table received from a service provider to determine if any received routes vary from the expected routes, and generating an alert if any unexpected routes are detected. Embodiments of the method can be implemented as program code executable by a customer edge router which has visibility to the received routes and can send SNMP (Simple Network Management Protocol) traps (messages) to a monitoring system. Alternatively, the method can be implemented by a monitoring system coupled to the customer edge router via code executable therein.

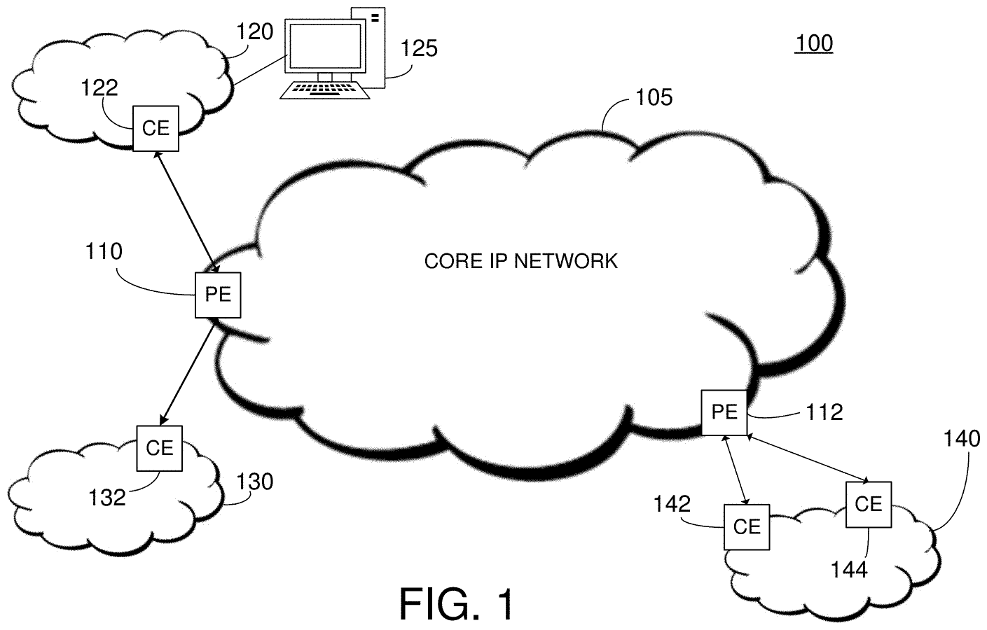

FIG. 1 is a schematic diagram of an exemplary IP data communication network in which the methods disclosed herein can be implemented. The network 100 comprises a core IP network 105 to which one or more network service providers are directly coupled. In the example depicted, a first service provider employs an edge router (PE) 110 to provide data connectivity between the core IP network 105 and two customer networks 120, 130. A second service provider employs another edge router (PE) 112 to provide data connectivity between the core IP network 105 and a third customer network 140. Provider edge router 110 is communicatively coupled to the customer edge (CE) router 122 of the customer network 120 and to the customer edge router 132 of customer network 130. Provider edge router 112 is communicatively coupled to two customer edge routers 142, 144 of customer network 140. Data communication between the provider edge routers 110, 112 and respective customer edge routers 122, 132, 142, 144 can be performed over any physical layer including any wired or wireless communication media. In some implementations, the provider edge routers 110, 112 and customer edge routers 122, 132, 142, 144 can exchange routing information using BGP. Each customer network 120, 130, 140 can be implemented as a VPN site with a static IP address range.

In FIG. 1, a monitoring device 125 is shown coupled to customer network 120. The monitoring device 125 can be any computing device that is configured to execute code for implementing a monitoring tool that can inspect packet communications on the customer network 120 and which has routing capability. The monitoring device 125 has secure access to network 120 and to CE router 122, for example using a secure shell (SSH). A similar monitoring device can be implemented on the other customer networks 130, 140 as well. Monitoring device 125 preferably has the capability to form BGP neighborship with at least one of the CE routers of the network to which it is coupled.

The provider edge routers 110, 112 and customer edge routers 122, 132, 142, 144 are devices that are configured to forward data packets based on network and other information based on known protocols. The routers can include, for example, a processor, input and output communication interfaces, and memory, among other components. The router processors are configured by program code (or firmware) to perform routing table computations and to process of data packets. In some implementations the routers are standalone devices, while in other implementations the routers can be implemented using general purpose computer systems or network devices.

PE router 110, which communicates with more than one (two) customer networks 120, 130, can create an instance of a routing table and a forwarding table (collectively referred to as “routing tables”) for each of the networks to separate the data traffic to and from the two networks. Each routing table is populated from routes received from directly connected CE sites associated with that VRF routing instance and from routes received from other PE routers that passed BGP community filtering and are in the same VPN. Importantly, due to the multiple instances of the routing tables in VRF, the same or overlapping IP addresses can be used without conflicting with each other. While this redundant use of IP addresses is very useful in conserving IP addresses, it is a potential source of route leakage. Any client that is part of a customer networks 120, 130 can access only the routes in its own VRF table instance. PE router 112 communicates with two customer edge routers 142, 144 that are administered using the same network (VPN). In this case PE router 112 creates a single routing table instance for the network that is received by both CE routers 142, 144. Each network 120, 130, 140 only has access to its own VRF routing tables and routing tables of other networks are invisible with respect to each other.

The PE routers 110, 112 and CE routers 122, 132, 142, 144 can employ BGP in communications to facilitate routing. BGP employs AS path extensions to distinguish routes (a.k.a. “route distinguishers”) that are intended to make route targets unique. An example AS path distinguisher is an ordered list of the identifiers of all autonomous systems through which a packet travels from a source to a target (e.g., 34 353 22, 11 12 13, and 22 13). A route target is also identified by an IP address (e.g., 32-bit address) that includes a network prefix (e.g., 24/32 bits) that identifies the network (VPN) and a host ID (e.g., 8/32 bits) that identifies a particular target device within the network. An example IPv4 address is 10.23.172.0. A subnet can be identified using a portion of the host ID field (e.g., 3/8 bits). In this case, the first 3 bits of the final eight bits of the IP address are used to identify a sub-network and the last 5 bits of the final eight bits are used to identify target devices.

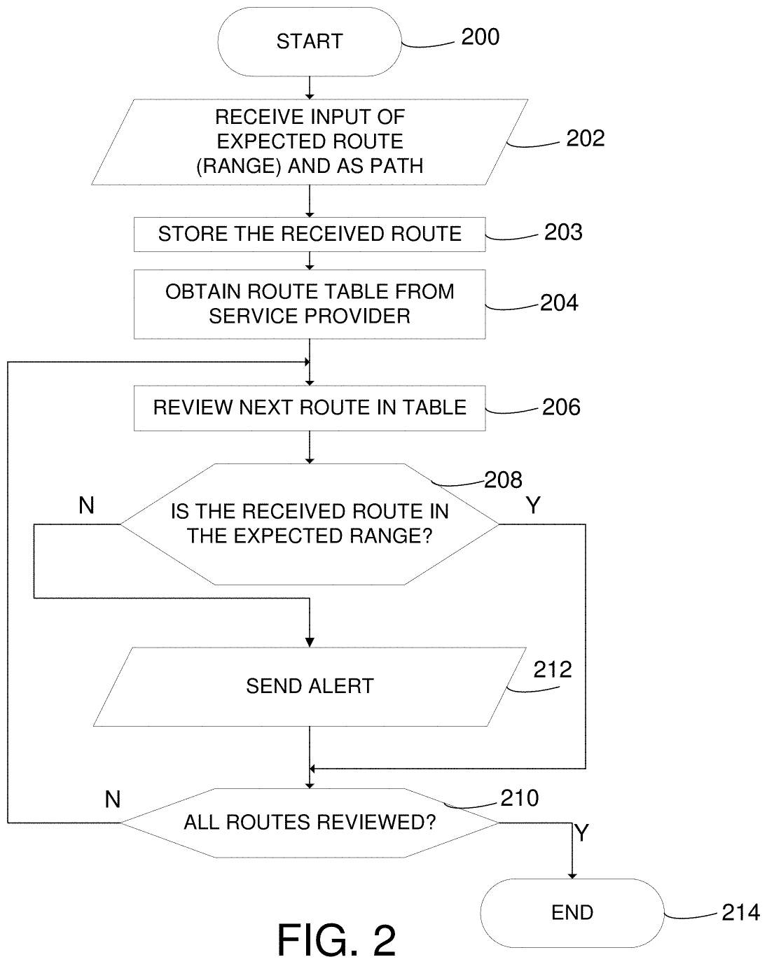

An embodiment of a method of detecting route leakage in the system described above is now described with reference to the flow chart of FIG. 2. The method can be implemented on CE routers 122, 132, 142, 144 using program code stored on the devices. Alternatively, the method can be implemented as a communication monitoring tool executed on a monitoring system having access to the CE routers and routing capability (e.g., monitoring device 125). The method beings in step 200. In a following step 202, an administrator, or other authorized technical professional responsible for maintaining a customer network, inputs an expected or expected range of routes for the customer network. In some implementations, the route is defined by IP addresses and can be entered subnet by subnet, as a range of IP addresses. In other implementations the route is defined by an AS path, and can be entered either as a list of autonomous systems or as a complete AS path list. An AS path can also be expressed using regular expressions. In further implementations, both IP addresses and AS paths can be used. The “expected route” is the route that is expected to appear in a virtual routing and forwarding table received by the customer network edge router from the provider edge router. Significantly, the prefixes and AS paths can be private to the customer network, with no relationship between a prefix and its AS owner. This fact can cause other systems which work with public AS and public networks to fail to detect private AS and private network ranges.

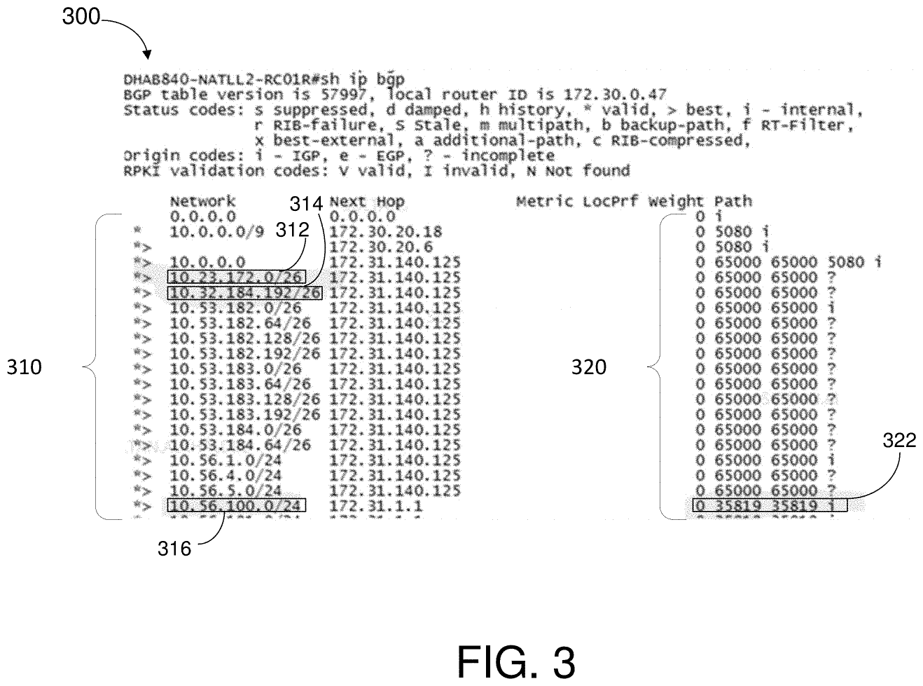

In step 203, the received expected routes and/or paths are stored in the memory of the CE router or monitoring device. In step 204, a VRF routing table having a listing or routes is received from the provider edge router of the service provider. An example of a VRF routing table is shown in FIG. 3. The table 300 includes a first list 310 of the IP addresses of all subnets appearing on the customer network, and a list of AS paths of the customer network 320. In the depicted example, the expected routes are either in the range of 10.48.0.0/20 or three default routes 10.0.0.0/8, 10.0.0.0/9 and 10.128.0.0/9. The expected AS path contains 65000 or 5080. In the IP address list 310, routes labeled 312, 314 are unexpected. Similarly, in the AS path list, the route labeled 322 is unexpected. While the route for this path 316 is expected, it is still highlighted because the AS path 322 associated with this route is unexpected.

In step 206, the first line of the VRF routing table is scanned (read). In step 208, program code causes the processor of the CE router or other monitoring device to determine whether the scanned route is one of the expected routes or AS paths listed in the table are not expected routes (i.e., if scanned route/AS path one of expected routes/AS Paths). With respect to IP address routes, this determination can be made subnet by subnet or by determining whether a listed range is within an expected range. With respect to AS paths, the determination can be made by ascertaining whether any AS in a received AS path is different from an expected AS or by comparing complete AS paths. If it is determined, in step 208, that the scanned route is expected, in step 210 it is determined whether all of the routes in the table have been reviewed. If not, the method cycles back to step 206 in which the next route listed in the routing table is scanned. If it is determined, in step 208, that the scanned route is not expected, program code causes the processor to generate an alert in step 212. The alert can be a SNMP message that is sent by the CE router (or other monitoring system) to a monitoring device. In implementations in which a monitoring device is used to implement the disclosed method, the alert can be delivered to a monitoring application executed by the same device, or to a different monitoring device coupled to the customer network. The monitoring device receiving the alert can automatically respond by sending a communication to inform the service provider or the network administrator that an unexpected route has been received in the routing table. The method ends in step 214.

Embodiments of the method of detecting network leakage described above can be used to ensure that VPN connections remain private. If privacy is violated, an alert is automatically generated that allows the customer and service provider to investigate any unexpected strange route discovered, isolate the route, and prevent potential damage to the network.

In some implementations, the alert can trigger a security feature and include data regarding any leaked routes. For instance, in cases in which unexpected routes received in the route table are actually legitimate (e.g., part of a range inadvertently not included in the list of expected routes), previously stored expected routes can be updated if agent-approved. Approval can be performed by an IT administrator, or in some implementation, by a daemon programmed to serve as an automated agent for approving certain increments to previously-stored expected routes for storage. In this way, particular implementations of the invention can have the expected and approved routes updated without manual entry.

In addition, a security feature can treat the leaked route data as an artifact to be tested for security risks and maliciousness. In some implementations, leaked route data and any metadata that derived therefrom can be analyzed by a system as described in commonly-owned and assigned application Ser. No. 16/272,542, filed Feb. 25, 2019, entitled “System and Method for Forensic Artifact Analysis and Visualization,” assigned to the present assignee and which is hereby incorporated by reference. In this system, the artifact can be queued for analysis and metadata extraction through a number of machine learning algorithms. Any information obtained by analysis of route leak artifacts can be stored in a centralized database for reference.

The present system and method, in particular, the monitoring method that is not necessarily implemented in a CE router, may be practiced on any computing device including a desktop computer, laptop computer, tablet computer, smart phone or other smart handheld device. The present system and method may also be implemented as a computer-readable medium that includes computer program code to enable one or more computer devices to implement each of the various process steps in a method in accordance with the present invention. It is understood that the terms computer-readable medium comprises one or more of any type of physical embodiment of the program code. In particular, the computer-readable medium can comprise program code embodied on one or more storage devices such as semiconductor cache memory, flash drives, optical discs, magnetic disk, tape, etc.

In addition, in certain embodiments, the methods disclosed above can also be performed in private MPLS (multiprotocol label switching) networks in which the customer has its own network segregation. The method can be used to detect inter-VRF route leakage. In this case the method can be performed in a PE router having connectivity to all virtual routes.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components and/or steps described and illustrated with reference to the figures are required for all embodiments or arrangements.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing, and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of detecting route leakage in a network performed by a processor coupled to the network, the method comprising:
receiving input of one or more expected routes for the network;
storing the received input;
receiving a routing table from an IP service provider;
determining whether the routing table contains any routes that vary from the one or more expected routes; and
generating an alert to a monitoring device if is determined that the routing table contains routes that vary from the one or more expected routes.

2. The method of claim 1, wherein the input one or more routes includes one or a list and a range of IP addresses.

3. The method of claim 1, wherein the input one or more route includes one of a list of autonomous systems (AS), a complete AS path, and an AS path described as a regular expression, used in border gate protocol (BGP) messaging.

4. The method of claim 1, wherein the input one or more routes includes both a) one of a list and a range of IP addresses, and b) one of a list of autonomous systems (AS), a complete AS path, and an AS path described as a regular expression, used in border gate protocol (BGP) messaging.

5. The method of claim 1, wherein the network is a virtual private network.

6. The method of claim 1, further comprising:
at the monitoring device, generating a communication to inform at least one of the IP service provider and a network administrator of a route leak received by the network.

7. The method of claim 1, wherein the method is performed at a customer edge (CE) router of the network coupled directly to a provider edge (PE) router of the IP service provider.

8. The method of claim 1, wherein the method is performed by a monitoring system coupled to the network.

9. The method of claim 1, further comprising communicating the generated alert so as to trigger a security feature employed in the network.

10. The method of claim 9, wherein the security feature includes an artifact analysis system that analyzes the routes that vary from the one or more expected routes and stores the routes in a centralized database.

11. A non-transitory computer-readable medium comprising instructions which, when executed by a computer system, cause the computer system to carry out a method detecting route leakage in a network including steps of:
receiving input of one or more expected routes for the network;
storing the received input;
receiving a routing table from an IP service provider;
determining whether the routing table contains any routes that vary from the one or more expected routes; and
generating an alert to a monitoring device if is determined that the routing table contains routes that vary from the one or more expected routes.

12. The non-transitory computer-readable medium of claim 11, wherein the input one or more routes includes one or a list and a range of IP addresses.

13. The non-transitory computer-readable medium of claim 11, wherein the input one or more route includes one of a list of autonomous systems (AS), a complete AS path, and an AS path described as a regular expression, used in border gate protocol (BGP) messaging.

14. The non-transitory computer-readable medium of claim 11, wherein the input one or more routes includes both a) one of a list and a range of IP addresses, and b) one of a list of autonomous systems (AS), a complete AS path, and an AS path described as a regular expression, used in border gate protocol (BGP) messaging.

15. The non-transitory computer-readable medium of claim 11, wherein the network is a virtual private network.

16. The non-transitory computer-readable medium of claim 11, further including instructions for performing the step of:
at the monitoring device, generating a communication to inform at least one of the IP service provider and a network administrator of a route leak received by the network.

17. The non-transitory computer-readable medium of claim 11, wherein the code is executed by a customer edge (CE) router of the network coupled directly to a provider edge (PE) router of the IP service provider or is executed by the PE router.

18. The non-transitory computer-readable medium of claim 11, wherein the code is executed at a monitoring system coupled to the network.

19. The non-transitory computer-readable medium of claim 11, further including instructions for performing the step of communicating the generated alert so as to trigger a security feature employed in the network.

20. The non-transitory computer-readable medium of claim 19, wherein the security feature includes an artifact analysis system that analyzes the routes that vary from the one or more expected routes and stores the routes in a centralized database.
